(19) United States
(12) Patent Application Publication
(10) Pub. No.: US 2002/0112339 A1
(43) Pub. Date: Aug. 22, 2002

(54) Method for manufacturing moulds suitable for plastic injection

(76) Inventor: Angel Condes Condes, IBI (ES)

Correspondence Address: SUGHRUE, MION, ZINN, MACPEAK & SEAS, PLLC, 2100 Pennsylvania Avenue, N.W., Washington, DC, 20037-3202, US

(21) Appl. No.: 09/780,483

(22) Filed: Feb. 12, 2001

(51) Int. Cl. B23P 17/00

(52) U.S. Cl. 29/527.5

(57) ABSTRACT

The invention relates to a method for manufacturing molds suitable for plastic injection consisting of a CAD geometry. To which parting lines are added, thereby obtaining a negative CAD insert is then converted into an STL file. The negative of the prototype is built in a stereolithographic machine and the refined and polished, the metal being manufactured in cooper or nickel by electrodeposition or galvanoplasty and the resulting cavity in the metal insert being filled with iron founding or the like.

### OBJECT OF THE INVENTION

The present descriptive account relates to an application for an Invention Patent, relative to a method for manufacturing moulds suitable for plastic injection, the purpose of which lies in obtaining from same a mould for plastic injections, whose inserts have been done without chip release using CAD or computer assisted design, as well as the STL system to build the insert in three dimensions, using galvanoplasty for the metallic cover of the prototype and founding for the filling of the prototype, the assembling of the mounted mould being carried out in the traditional way.

### FIELD OF THE INVENTION

This invention is applicable to the industry specializing in the manufacture of moulds for plastic injection.

### BACKGROUND OF THE INVENTION

The applicant knows of the existence of a project which dates from the year 1998, relative to the introduction of innovative technology in the manufacturing process of plastic parts by means of rapid prototyping and tooling.

After carrying out an important study on said project, it has been found that master parts can be built with amazing quality, precision and speed.

As a consequence of the aforementioned, moulds for obtaining parts have been built, having followed on with the project, but the existence of a fundamental drawback has been determined consisting of the fact that only a single part for each mould can be obtained.

Therefore, knowing the needs of all the producers of plastic materials parts, which consist of obtaining a minimum of 100 parts and with definitive materials, research has been focused on obtaining quick and precise moulds for adapting to existing current demand.

It has been seen that a huge gap is to be found in this current demand not only on a European level, but also on a world level, a situation which was directly confirmed at the EUROMOULD trade fair, considered the most important trade fair in the technical sector, wherein it was confirmed that the technologies displayed there did not fulfill the requisites demanded by the manufacturers, these being mainly, quality and precision, from whose anomalies stem a main factor, in particular, the delivery date.

The obvious solution to the problems existing at present would be to have a method for manufacturing moulds, suitable for plastic injection, in which a quality with specular polishing, textured, which allows the reproduction of the CAD drawing, the injection being carried out in any type of technical plastic with a precision of 0.05 millimeters, saving 40% of the time as far as delivery dates are concerned, and with a saving of 35% regarding the final cost.

Nevertheless, the applying party has no knowledge of the existence at the present time of an invention which is equipped with the features previously pointed out as being ideal.

### DESCRIPTION OF THE INVENTION

The method for manufacturing moulds suitable for plastic injections which the invention proposes, in itself constitutes an obvious novelty within its field of application, achieving a mould for plastic injection whose inserts have been done without chip release with high quality delimited precision, time-saving and final product price.

More specifically, the method for manufacturing moulds, suitable for plastic injections, object of the invention, is constituted from a CAD geometry design, that is to say, done by computer, to which parting lines are added, and starting from this addition, the inserts are obtained in the way they are going to be used in the mould.

Once the CAD insert is obtained, the insert negative in question must be built, an operation which, like the previous ones, is done by CAD, and once this process is finalized, it is converted into a STL file for the file to be built in three dimensions, in particular, for the negative of the prototype to be built in a stereolithographic machine.

When this part created by the machine is ready, it undergoes refining and polishing.

In order to obtain the metallic insert in copper, nickel, etc., it is done by electrodeposition or galvanoplasty, meaning that a metallic thickness for the prototype will be obtained according to the time it is situated inside of the bath.

Once this process has ended, the resulting cavity is filled with founding of iron, aluminum, copper, bronze or epoxy resin, with the aim of obtaining a solid insert in order to be able to make refrigeration channels, make the ejection, machine at the material entrance and be able to screw it to the mould-holder.

The final result is a mould for plastic injection, the inserts of which have been done without chip release.

The invention, in the same way, allows for the obtainment of electrode constructions for electroerosion machines.

### PREFERRED EMBODIMENT OF THE INVENTION

The method proposed for manufacturing moulds suitable for plastic injection is constituted starting from the preparation of the plans, each part's ways and means of operation, then going on to the graphic work station, and with Solid View software the three-dimensional CAD designs will be worked on with the aim of obtaining the files of the parts and prototypes desired.

Subsequently, with these files and with a stereolithographic machine one proceeds to the building of the master male die in photosensitive resin, using a laser beam, which has a very high degree of precision.

Once the master parts are obtained the next step is the building of the inserts of the parts for the moulds using metallic replacement and in this phase different deposition technologies have to be tried, following the advice of the specialist in surface treatments.

Once the metallic inserts are obtained they have to be machined externally to obtain the desired dimension in each prototype, as well as equipping them with centering drill holes.

Having finished the prototype phase the next step is to go on to its insertion in the mould-holder, done in the moulds workshop providing it with all the necessary mechanisms and workings so that they operate like any other traditional mould.

Finally, the mould tests shall be carried out, as well as the results obtained in the different phases, both in the precision of the parts and in the different materials which they will be able to produce.

A milling-machine, grinder and column drills with the relevant accessories shall be used as auxiliary machinery.

1. Method for manufacturing moulds suitable for plastic injection, characterized in that it is constituted starting from cad geometry, to which parting lines are added thereby obtaining the inserts which are going to be employed in the mould, the designs being done in three dimensions and once the CAD insert is obtained, a negative insert, also in cad, is built, which is then converted into a STL file for the negative of the prototype to be built in a stereolithographic machine, then the parts created by the stereolithographic machine being refined and polished.

2. Method for the manufacturing of moulds suitable for plastic injection, in accordance with the first claim, characterized in that the master male parts will be manufactured in photosensitive resin using laser beam.

3. Method for manufacturing moulds suitable for plastic injection, in accordance with the previous claims, characterized in that the obtaining of the metallic insert in copper or nickel is done by electrodeposition or galvanoplasty, with an artificial metallic thickness in accordance with the time maintained inside the bath.

4. Method for manufacturing moulds suitable for plastic injection, in accordance with the previous claims, characterized in that the resulting cavity in the metal insert is filled with founding of iron, aluminum, copper, bronze or epoxy resin, a solid insert being obtained, provided with centering drills, then being inserted in the mould holder.
